(19) United States
(12) Patent Application Publication
(10) Pub. No.: US 2008/0121341 A1
(43) Pub. Date: May 29, 2008

(54) RADIATION CURABLE ADHESIVE WITH HIGH MOLECULAR WEIGHT OLIGOMER

(75) Inventor: Leo M. Landoll, Hockessin, DE (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: APPLIED EXTRUSION TECHNOLOGIES, New Castle, DE (US)

(21) Appl. No.: 11/943,828

(22) Filed: Nov. 21, 2007

Related U.S. Application Data
(60) Provisional application No. 60/867,462, filed on Nov. 28, 2006.

(51) Int. Cl. B29C 65/14; C08F 2/46

(52) U.S. Cl. 156/273.3; 522/90

(57) ABSTRACT

An adhesive composition preferably contains: (1) an oligomer of at least 10,000 Da and an average functionality from 1-2; (2) a monomer; (3) an initiator; and optionally (4) a tackifier. The composition preferably has: (a) tack sufficient to pull labels from a magazine at 350 ft/min linear speed and/or at 750 labels/min without dropping more than 0.5% of all labels in a five-minute test; (b) a viscosity of 1,000-2,500 cps in an uncured state; (c) a peel strength greater than 1200 gm/3 inches when cured to 90% of monomer as measured with a glass bottle at a temperature of 75° F. (23.9° C.); (d) curing efficiency sufficient to cure to 90% of monomer within 1 sec of being radiated with 12 mJ/cm² of UVC light; and (e) an ability to cure to provide a substantially bubble-free surface. The composition is particularly adapted for use as a radiation-curable adhesive for labeling containers.

### BACKGROUND OF THE INVENTION

1. Field of Invention

This invention relates to radiation curable adhesives, and in particular to UV curable adhesives suitable for use in a high throughput labeling system.

2. Description of Related Art

U.S. Pat. No. 6,517,661 B2 to Hill et al. discloses a labeling apparatus and method for applying labels to containers using a radiation curable adhesive. In preferred embodiments of Hill et al., uncured adhesive is applied to labels and must be minimally tacky such that the labels adhere to transfer pads of the apparatus. The individual labels carried on the transfer pads are then directed to a transfer assembly, wherein the adhesive-coated labels are released from the transfer pads and directed by the transfer assembly through an ultraviolet (UV) cure station in which the adhesive is rendered sufficiently tacky to permit the label to be reliably and effectively adhered to an outer surface of a container, and then into a label application station for transferring each individual label, with the sufficiently tacky adhesive thereon, to the outer surface of a container, preferably a glass container, such as a beer or soda bottle, to thereby effectively adhere the label to the container.

These embodiments of Hill et al. pose several challenges for adhesives. First, the adhesive in the uncured state must be minimally tacky such that the labels releasably adhere to transfer pads of the apparatus. Second, the adhesive should cure with sufficient alacrity such that throughput speeds of up to 400 ft/min or more are achievable. Third, the adhesive must be effectively adhered to the container surface in a commercially reasonable time frame of, e.g., 24 hours or less. Fourth, the adhesive should preferably work transparently with transparent labels with little or no visible bubbles. Fifth, the adhesive should preferably be sufficiently cohesive such that the label and adhesive can be cleanly removed from the container, providing an unlabeled container that can be gripped on its previously labeled surface without a tacky feel.

Certain highly crosslinked adhesives have been employed in the Hill method, but their performance was less than ideal. These adhesives (e.g., adhesive formulations such as Formula C12G discussed in the Examples below) had great difficulty in achieving good appearance, and required large amounts of liquid rubbers and non-reactive solvents to allow enough wetting and to get sufficient tack. Even then, they did not heal all the bubbles in the labeling process. They were also very slow to cure, i.e., at labeling speeds, there was insufficient light energy density, so processes had to slow down.

Accordingly, it is desired to provide improved adhesives that are particularly suitable for use in the apparatus and method of Hill et al. It is further desired to provide improved adhesives that meet at least one (and preferably all) of the five challenges described above.

All references cited herein are incorporated herein by reference in their entireties.

### BRIEF SUMMARY OF THE INVENTION

Accordingly, a first aspect of the invention comprises an adhesive composition comprising:

at least one oligomer having a weight average molecular weight of at least 10,000 Da and an average functionality from 1 to 2;

at least one monomer;

at least one initiator; and

optionally at least one tackifier.

A second aspect of the invention comprises an adhesive composition comprising:

at least one oligomer having a weight average molecular weight of at least 10,000 Da and an average functionality from 1 to 2;

at least one monomer;

at least one initiator; and

optionally at least one tackifier,

wherein the adhesive composition possesses all of the following properties: (a) tack sufficient to pull labels from a magazine at 350 ft/min linear speed and/or at 750 labels/min without dropping more than 0.5% of all labels in a five-minute test; (b) a viscosity of 1,000 to 2,500 cps in an uncured state; (c) a peel strength greater than 1200 gm/3 inches when cured to 90% of monomer as measured with a glass bottle at a temperature of 75° F. (23.9° C.); (d) curing efficiency sufficient to cure to 90% of monomer within 1 sec of being radiated with 12 mJ/cm² of UVC light; and (e) an ability to cure to provide a substantially bubble-free surface.

A third aspect of the invention comprises an improved process for applying a label to a surface of a container, comprising applying a radiation curable adhesive to a transfer member, transferring the adhesive from the transfer member to a label, irradiating the adhesive on the label to cure the adhesive and applying the label to the surface of the container before the adhesive has cured, wherein the improvement comprises using the adhesive composition of the invention as the radiation curable adhesive.

A fourth aspect of the invention comprises a copolymer produced by polymerizing the adhesive composition of the invention.

### DETAILED DESCRIPTION OF PREFERRED EMBODIMENTS OF THE INVENTION

The invention is based in part on the discovery that high molecular weight oligomers provide adhesives having sufficient tack and healing properties without the need for large amounts of tackifier and without non-reactive fillers, such as rubber and solvents. The high molecular weight oligomers also provide the adhesives with desirable rheological properties. The relative absence of non-reactive fillers enables fast curing as a result of the higher concentration of active polymerization components (i.e., monomer(s) and oligomer(s)).

Preferred Properties of the Adhesive

Thus, adhesives of the invention are characterized by one, more than one (in all possible combinations and permutations) or all of the following properties: (a) minimal tack in the uncured state; (b) workable viscosity; (c) effective adhesion; (d) rapid and energetically efficient curing; (e) substantially no visual defects; and (f) effective cohesiveness. These properties are addressed in greater detail below.

(a) Minimal Tack in the Uncured State

Reference throughout this application to the adhesive having “minimal tack” or being “minimally tacky” refers to a tacky condition that is sufficient to engage and remove the lowermost label from a stack of cut and stack labels retained in a magazine, but which is not so strong as to either preclude peeling of the label off of the transfer pad at a subsequent cure station, or to permit the uncured adhesive to consistently, reliably and effectively adhere the label to a container in a commercial labeling system and method.

In certain embodiments, the minimum tack is sufficient to pull labels from a magazine at 350 ft/min linear speed and/or at 750 labels/min without dropping more than 0.5% of all labels in a five-minute test. A 60×90 mm label is used in this test, although the size of the label is not thought to have a significant impact on this test (or in the method of using the composition of the invention for that matter).

In certain embodiments, the maximum tack is sufficient to remove the label from the magazine at 350 ft/min linear speed and/or at 750 labels/min with uniform coat weight and good clean print (anilox) appearance.

(b) Workable Viscosity

Adhesives of the invention possess a viscosity sufficiently low so as to permit the uncured adhesive to be applied substantially uniformly over a label surface. Preferably, the viscosity of the uncured adhesives usable in this invention is in the range of about 500 to about 5,000 centipoise (cps); more preferably under 4,000 cps; still more preferably in the range of about 800 to about 3,000 cps and most preferably in the range of 1,000 to 2,500 cps.

The viscosity of the adhesive and the tack of the adhesive are related properties. If viscosity and tack are too low, the failure rate for pulling labels from the cartridge is too high. On the other hand, if viscosity and tack are too high, when the gripping members (52) pull the label from the transfer pads (32), the adhesive will string out excessively (i.e., exhibit excessive Saffman-Taylor fingering), and the label will have a non-uniform coatweight and areas of thick adhesive and/or areas devoid of adhesive (see FIG. 1 of Hill et al.).

A further limitation on the viscosity and tack of the adhesive is in the printing process. Excessively viscous adhesives tend to be too thick and will not print the labels uniformly, with Saffman-Taylor fingering slinging adhesive all over the labeling apparatus.

(c) Effective Adhesion

Reference in this application to a label being “effectively adhered” to a container, or to the “effective adherence” of a label to a container, or words of similar import, means that the label is required to be secured to the container in a manner that precludes the edge regions or body thereof from unacceptably separating from the container wall during handling and use of the container, and most preferably, although not required within the broadest scope of this invention, in a manner that prevents an individual from easily peeling the label off of the container.

Preferred adhesives of the invention, when cured to 90% of monomer, have a peel strength greater than 1200 gm/3 inches, more preferably greater than 2000 gm/3 inches, and most preferably greater than 2300 gm/3 inches. Peel strength is measured using a hand-held tension meter (Imada DPS-44) with a freshly labeled glass bottle at a temperature of 75° F. (23.9° C.).

(d) Rapid and Energetically Efficient Curing

To acquire sufficient adhesion to resist the movement of labels on conveyor lines requires a high shear strength adhesive, attained by crosslinking. Adhesives of the invention having a thickness of 0.5 mil are preferably capable of curing sufficiently within 1 sec of being radiated with 12 mJ/cm² of UVC light (as measured with an EIT UV POWER PUCK) to provide a label effectively adhered to a container. Certain embodiments of the inventive adhesive cure to provide an effectively adhered label within 0.75 sec or within 0.50 sec or within 0.25 sec or within 0.15 sec of being radiated with such UVC light.

Preferred adhesives of the invention cure to 90% (based on monomer conversion as measured by extractive gas chromatography) within 1 sec of being radiated with 12 mJ/cm² of UVC light. Certain embodiments of the inventive adhesive cure to 90% within 0.75 sec or within 0.50 sec or within 0.25 sec or within 0.15 sec of being radiated with such UVC light.

Thus, preferred adhesives of the invention are capable of curing with less than half the energy requirements of current adhesives, enabling high speed throughput in a labeling system employing the adhesive.

(e) Substantially No Visual Defects

A particularly unexpected finding was that the increase in molecular weight of the oligomer allows the adhesive to be applied at high speed with fewer air bubble inclusions. Without wishing to be bound by any particular theory, it appears that bubbles are minimized because the shear strength/resistance of the adhesive at application allows the label to be pressed fully to the surface without trapping air.

Adhesives of the invention are capable of providing labeled containers free or substantially free of bubbles in the adhesive. As used herein, the expression “substantially free of bubbles” means that when a representative area of adhesive is analyzed, less than 1% of the area appears to be occupied by bubbles. In preferred embodiments, less than 0.9%, less than 0.8%, less than 0.7%, less than 0.6% or less than 0.5% of the area is occupied by bubbles.

In the most preferred embodiments of this invention, particularly when the labels are transparent and are adhered to clear containers, the adhesive has the ability to cold flow while curing on a container to fill in imperfections, e.g., striations, in the initial distribution of the adhesive on the label. An adhesive thickness in the range of about 1 to about 1.5 mils has been determined to cold flow after application of the label to the container, to fill in unsightly striations and other visual defects in the adhesive layer. More preferably, the adhesive thickness is 0.4-0.6 mil or about 0.5 mil. Excessive thickness of the adhesive layer results in unacceptably slow curing. Insufficient thickness of the adhesive layer results in a poor bond.

In addition, the adhesive should be capable of clearing all anilox print patterns and bubble defects in less than 48 hours.

(f) Effective Cohesiveness

Adhesives of the invention should preferably be sufficiently cohesive such that the label and adhesive can be cleanly removed from a container to which they have been previously applied, providing an unlabeled container that can be gripped on its previously labeled surface without a tacky feel. Cohesive strength of the adhesive should exceed adhesion strength of the adhesive with respect to the substrate to which the label is adhered.

Preferred Formulations of the Adhesive

Preferred Formulations of the Adhesive include at least one oligomer, at least one monomer, and at least one initiator. The formulations optionally include at least one tackifier as an additional ingredient. The oligomer(s) and monomer(s) of the formulation polymerize to form copolymers of the invention.

(a) Oligomer(s)

In the context of the present invention, oligomers are molecules comprising a plurality of repeating units derived, actually or conceptually, from molecules of lower relative molecular weight.

At least one high molecular weight oligomer must be included in the adhesive formulation. The oligomer must have a molecular weight of at least 10,000 Daltons (all molecular weights referenced herein are weight average molecular weights as measured in Daltons, Da, unless otherwise noted). More preferably, the oligomer has a molecular weight of at least 12,000 Da or at least 15,000 Da or at least 20,000 Da. The upper limit on the molecular weight is not particularly limited, with oligomers of molecular weights of 30,000 Da, 40,000 Da or up to 50,000 Da being contemplated for use in the invention.

If the molecular weight of the oligomer is too low (e.g., about 5,000 Da or less), the resulting adhesive contains excessive crosslinking and is incapable of adequately healing fine bubbles. If the molecular weight of the oligomer is too high, the viscosity of the adhesive will also be too high, resulting in the problems discussed above with respect to high viscosity. In certain embodiments, the molecular weight of the oligomer should not be so high that an uncured adhesive formulation containing 5 wt. % of the oligomer has a viscosity exceeding 3000 cps.

Suitable oligomers include reactive groups which are capable of reacting with monomers to form cross-linked copolymers. Preferred oligomers have an average functionality greater than 1 and as high as 2. Certain embodiments of the invention contain oligomers having an average functionality of about 1.6. An average functionality of 1 can be effective for very high molecular weight oligomers, such that entanglements of the oligomer (which in essence is only a side chain) create an effective elasticity to give shear strength.

Urethane acrylates are the most preferred oligomers for use in adhesives of the invention. Suitable end groups for the oligomers are not particularly limited, and include but are not limited to aromatic and aliphatic moieties. At present, the most preferred oligomer is PRO5541, a 20,000 Da oligomer with a functionality of 1.6 (available from Sartomer Co., Inc. of Exton, Pa.).

The oligomer should preferably have a Tg below room temperature, more preferably below 0° C., and most preferably below −25° C., and as low as −50° C., −75° C., −100° C. or lower. Glassy adhesives based on high Tg oligomers cannot heal small bubbles. The final adhesive should be a rubber at room temperature in order to heal, in its cured form. The monomers are preferably mixed so that by a Flory-Fox model (known to those skilled in the art), the mixture has a Tg most preferably below −25° C., and as low as −50° C., −75° C., −100° C. or lower. The Tg of the mixture can be up to 0° C. if the bottles are to undergo pasteurization.

(b) Monomer(s)

In the context of the present invention, monomers are molecules which can undergo polymerization, thereby contributing constitutional units to the structure of the copolymer formed by the adhesive formulation.

Monomers are preferably chosen from those known to have Draize irritation factors of 1 or less. Preferably, the final adhesive does not cause skin irritation from any traces of unreacted monomer. Suitable monomers include but are not limited to isobornyl acrylate monomers (e.g., SR506D from Sartomer), alkoxylated phenol acrylate monomers (e.g., CD9087 from Sartomer) and acrylic monomers (e.g., CD420 from Sartomer).

The ratio of monomers in a blend is chosen to ensure that the adhesive is rubbery at room temperature. The optimal ratio can be influenced by the temperature at which the container is labeled. Lower processing temperatures call for a lower Tg monomer mix.

(c) Initiator(s)

Initiators are substances that initiate polymerization. Preferred initiators are chosen to match lamp spectral emissions and used at levels that give sufficient cure. For example, KIPCURE 150 works well at concentrations of 5% or more with a mercury UV lamp emitting the UVC spectrum.

Radiation-curable adhesives employing free-radical initiators have a strong initial cure but provide a poor visual appearance. On the other hand, radiation-curable adhesives employing cationic initiators provide weak initial cure but have good visual appearance. By employing an adhesive including a blend of these two types of initiators, excellent results have been achieved.

(d) Tackifier(s)

Tackifiers are additives which increase the tack of the adhesive.

The tackifier is an optional ingredient, particularly with respect to adhesive formulations containing an oligomer having a molecular weight greater than 20,000 Da. At present, NORSOLENE S85 (Sartomer) is a preferred tackifier; however, persons skilled in the art will appreciate that other tackifiers can be substituted or blended with said tackifier to alter the properties of the resulting adhesive in a predictable manner. For example, NORSOLENE A110 (Sartomer) has a higher Tg than NORSOLENE S85, and that can change tack and peel properties, especially when used with very hot containers. Tackifiers with a Tg at least as high as that of A110 (64° C.) are preferred because they improve pasteurization resistance of the final product. Also, there are “purified” aromatic resins such as the NORSOLENE W series (Sartomer) that have fewer volatiles, and can be used to reduce odors from the adhesive.

Ingredients (a), (b), (c) and optionally (d) are combined in amounts effective to achieve the desired properties discussed above. Preferred ranges of these ingredients are given in Table 1 below. It should be understood that these concentration ranges vary somewhat with the molecular weights of the ingredients.

TABLE 1
Adhesive Formulation Ingredient Ranges (in wt. %).

| Ingredient | Preferred Range | More Preferred Range |
|---|---|---|
| Oligomer | 15-30 | 20-25 |
| Monomer | 30-75 | 50-60 |
| Initiator | 3-8 | 5-6 |
| Tackifier | 0-25 | 0-15 |

The monomer/oligomer ratio (by weight) is preferably from 1.8/1 to 5/1, and more preferably about 1.8/1 to 2/1 or 3/1. If the ratio is too low, there is excessive crosslinking in the adhesive, which is too viscous and traps too many bubbles. If the ratio is too high, there is insufficient crosslinking in the adhesive, which is insufficiently viscous.

The combined concentration of the oligomer(s) and the monomer(s) is preferably at least 67 wt. %, more preferably at least at least 75 wt. %, even more preferably at least 78 wt. %, and most preferably at least 90 wt. % of the adhesive composition.

The invention will be illustrated in more detail with reference to the following Examples, but it should be understood that the present invention is not deemed to be limited thereto.

### EXAMPLES

### Example 1

Adhesive formulations were prepared using as the oligomer BR3641AA (available from Bomar Specialties Co., Winsted, Conn.), which is a 13,000 Da, low Tg, difunctional oligomer. Once such adhesive formulation, having a viscosity of 1140 cps and a Monomer:Oligomer Ratio of 2.5, was prepared from the following ingredients:

| Ingredient | Type | Wt. % |
|---|---|---|
| CD9087 | Monomer | 32.2 |
| SR506 | Monomer | 21.4 |
| BR3641AA | Oligomer | 21.4 |
| NORSOLENE S85 | Tackifier | 20 |
| SARCURE SR1130 (Sartomer) | Initiator | 5 |

Because of the high molecular weight between the functional ends of the oligomer, the cured adhesive had reduced crosslink density. This enabled the use of a relatively high oligomer concentration, which builds viscosity and allowed for a reduction in the amount of tackifier, which would otherwise contribute to attaining desired viscosity levels. Increasing the amount of oligomer relative to tackifier also increased cure speed and improved internal cohesive strength of the adhesive such that at normal peel rates of 12 inches/min, it lifts cleanly from glass.

### Example 2

Adhesive formulations were prepared using as the oligomer BR3741AB (Bomar), which is a 13,000 Da oligomer with an average functionality of 1.6. Once such adhesive formulation, having a viscosity of 2127 cps and a Monomer:Oligomer Ratio of 3.5, was prepared from the following ingredients:

| Ingredient | Type | Wt. % |
|---|---|---|
| CD9087 | Monomer | 46.2 |
| SR506 | Monomer | 8.3 |
| BR3741AB | Oligomer | 15.5 |
| NORSOLENE S85 | Tackifier | 25 |
| SARCURE SR1130 | Initiator | 5 |

This formulation contained a relatively high percentage of non-reactive ingredients, but still had acceptable properties.

### Example 3

An adhesive having a viscosity of 2640 cps and a Monomer:Oligomer Ratio of 2.5, was prepared from the following ingredients:

| Ingredient | Type | Wt. % |
|---|---|---|
| CD9087 | Monomer | 23.1 |
| SR506 | Monomer | 15.4 |
| GENOMER 4188/M22 | Oligomer | 26.5 |
| NORSOLENE S85 | Tackifier | 30 |
| SARCURE SR1130 | Initiator | 5 |

GENOMER 4188/M22 is a product of Rahn AG (Switzerland), which is believed to contain a monofunctional urethane acrylate having a molecular weight of about 15,000 diluted in GENOMER 1122 monomer. The Monomer: Oligomer Ratio takes this into account (the total monomer percentage being 23.1%+15.4%+8% (Genomer 1122), and the oligomer percentage being 18.45%).

The adhesive was applied to transparent labels and applied to bottles using the Hill et al. process. The adhesive provided a clear label, but because of relatively low functionality and relatively low crosslinking, it had a propensity to form internal bubbles by coalescence of small bubbles. These cleared with time.

### Example 4

Adhesives were prepared using as the oligomers two 20,000 Da oligomers from Sartomer, PRO5540 and PRO5541. They differ in that the functionality of PRO5540 is 2.0, while the functionality of PRO5541 is 1.6.

In view of the increased molecular weight of the oligomers, the amount of tackifier was further reduced. At levels below 20% tackifier, the adhesive cure speeds increased substantially. At levels of 10% tackifier and below, the cure speeds are very fast, typically 2.3 times faster than a standard commercial adhesive suitable for use in the Hill et al. process, such as TCA C12G (available from Applied Extrusion Technologies, Inc., New Castle, Del.). Additionally, at levels of tackifier below 15%, the cohesive strength increases and lift from glass can be observed. As the oligomer level or average functionality increases, the cohesive strength increases and lift from glass becomes easier at higher deformation rates.

### Example 5

An adhesive formulation in accordance with the invention was compared with a prior art formulation. The following table shows the respective compositions of the current commercial adhesive C12G and a preferred embodiment of this invention, labeled C13G. The C12G oligomer is nominally a 5,000 Da, difunctional oligomer, while the C13G oligomer is nominally a 20,000 Da oligomer with an average functionality of 1.6.

TABLE 2
Comparative and Exemplary Adhesive Formulations.

| Ingredient | C12G (comparative) | | C13G (exemplary) | |
|---|---|---|---|---|
| Oligomer | CN9004 | 5 | PRO5541 | 22.8 |
| Monomer 1 | SR506 | 7.7 | SR506 | 4.0 |
| Monomer 2 | CD9087 | 30.9 | CD9087 | 34.0 |
| Monomer 3 | — | — | CD420 | 18.7 |
| Tackifier | Norsolene A110 | 35 | Norsolene S85 | 15 |
| Initiator | Kipcure 150 | 5 | Kipcure 150 | 6 |
| Rubber | Ricobond 2031 | 6.2 | | |
| Plasticizer | SR660 | 10.3 | | |

All materials were from Sartomer. Data sheets are on their website at Sartomer.com.

The use of only 5% of the low molecular weight oligomer results in excessive crosslinking and no healing of fine bubbles, even with 16.5% of low Tg materials (rubber and plasticizer) and 35% tackifier (necessary for strength, tack and especially to maintain viscosity and ability to pick labels). The high molecular weight oligomer can be used at high levels to get good viscosity, yet crosslinking density is low enough to allow complete healing of bubbles and a very clear label appearance.

The total monomer load in the comparative example is 38.6%, yet to get 90% conversion requires 21 mJ/cm² of UVC light (measured by an EIT UV POWER PUCK). By contrast, the monomer load in C13G is 56.7%, almost 50% greater, yet only 12 mJ/cm² of UVC light was required to obtain 90% monomer conversion (measured by extractive Gas Chromatography). This allows a significant increase in labeling speed.

Unexpectedly, the C13G adhesive allowed application with fewer bubbles. Bubbles are entirely dependent on the glass shape (flat spots) and machine (compression pressure). However, using the same bottle, application speed and pressure with an apparatus according to Hill et al., the C12G gave an average of 10-12% of major seam defect bubbles (greater than 2 cm high by 3 mm wide), while C13G gave an average of 1.5-4% major seam defect bubbles. (Each adhesive was cured with lamp power adjusted to give 90% conversion as outlined above.)

At 20,000 Da, the 1.6 functional PRO5541 can be used at levels up to 30% of the formula without inhibiting the clearing properties of the adhesive. Unfortunately, at this level viscosity for this particular oligomer is not high enough (a minimum of 800 cps desired), so that a preferred formula uses 25-30% PRO5541 with 5-15% tackifier. Cure speed is still sufficient for operation at 400 fpm, with good clarity, and cohesive strength to allow clean glass lift at low to moderate peel speeds.

The foregoing examples suggest that the ideal adhesive would be very high molecular weight oligomer (e.g., of 30,000 Da or higher), capable of being used at high levels to provide sufficient viscosity with no tackifier. As the molecular weight increases, the functionality can increase to maintain the same average crosslink density. The maximum suitable molecular weight of the oligomer is limited only by the need to maintain viscosity within the desired process upper limit (e.g., 3000 cps) when used at a level sufficient to give a crosslink density to maintain required shear strength.

Pure statistical calculation dictates that the further the distance between crosslink points and the fewer in number the crosslink points (dictated by the overall molecular weight of the oligomer), the higher the conversion that is necessary to reach a gel state, or incipient crosslinking. Without wishing to be bound by any particular theory, it appears that in the fractions of a second prior to applying the label to the container by the Hill et al. process, the adhesive has not yet attained a gel state, thus allowing the label to be smoothly applied without a shear resistance such that it is possible to smooth out many bubbles and improve the flow of the adhesive into surface defects prior to reaching a gel state at which flow is inhibited. This in turn leads to fewer and smaller defects that are more easily healed in a short time frame. The flexibility associated with a loose network with high molecular weight between crosslinks allows the relaxation of the anilox pattern such that the appearance is clear.

Increasing the amount of oligomer relative to tackifier also increased cure speed and improved internal cohesive strength of the adhesive such that at normal peel rates of 12 inches/min, it lifts cleanly from glass.

The foregoing Examples employ PRO5541, which Sartomer appears to have discontinued since the performance of the work described in the Examples. The product appears to have evolved into PRO10332, aka CN9018. Substitution of CN9018 for PRO5541 in formulations described above has yielded satisfactory results.

Moreover, the substitution of CN9018 into the formulations prompted the discovery that lowering the monomer/oligomer ratio to 2.0, or even 1.8, significantly improves shear resistance of the adhesive and is the preferred operating range. CN9018 has a target viscosity of 45K at 60° C., due to its much higher molecular weight relative to PRO5541. This enables the lower monomer/oligomer ratios without excessive crosslinking, yielding products having good clarity and shear resistance.

While the invention has been described in detail and with reference to specific examples thereof, it will be apparent to one skilled in the art that various changes and modifications can be made therein without departing from the spirit and scope thereof.

What is claimed is:

1. An adhesive composition comprising:
at least one oligomer having a weight average molecular weight of at least 10,000 Da and an average functionality from 1 to 2;
at least one monomer;
at least one initiator; and
optionally at least one tackifier.

2. The adhesive composition of claim 1, wherein the average functionality of the oligomer is 1.6.

3. The adhesive composition of claim 1, wherein the average functionality of the oligomer is greater than 1.

4. The adhesive composition of claim 3, wherein the at least one oligomer and the at least one monomer constitute at least 67 wt. % of the adhesive composition.

5. The adhesive composition of claim 3, wherein the at least one oligomer and the at least one monomer constitute at least 78 wt. % of the adhesive composition.

6. The adhesive composition of claim 3, wherein the adhesive composition consists essentially of the at least one oligomer, the at least one monomer and the at least one initiator.

7. The adhesive composition of claim 3, wherein the at least one oligomer and the at least one monomer are urethane acrylates.

8. The adhesive composition of claim 3, wherein the at least one oligomer is an aliphatic urethane acrylate.

9. The adhesive composition of claim 3, wherein the at least one oligomer has a weight average molecular weight of at least 12,000 Da.

10. The adhesive composition of claim 3, wherein the at least one oligomer has a weight average molecular weight of at least 15,000 Da.

11. The adhesive composition of claim 10, wherein the molecular weight of the at least one oligomer is less than or equal to 30,000 Da.

12. The adhesive composition of claim 10, wherein the molecular weight of the at least one oligomer is less than or equal to 50,000 Da.

13. The adhesive composition of claim 10, wherein a monomer:oligomer ratio is from 1.8:1 to 3:1.

14. The adhesive composition of claim 3, wherein a monomer:oligomer ratio is from 1.8:1 to 3:1.

15. The adhesive composition of claim 3, having a Tg less than 0° C.

16. The adhesive composition of claim 3, comprising the tackifier having a Tg of at least 64° C., wherein the adhesive composition has a Tg less than −25° C.

17. The adhesive composition of claim 3, wherein the adhesive composition possesses at least one property selected from the group consisting of: (a) minimal tack in an uncured state; (b) workable viscosity; (c) effective adhesion; (d) rapid and energetically efficient curing; (e) substantially no visual defects; and (f) effective cohesiveness.

18. The adhesive composition of claim 14, wherein the adhesive composition possesses all of the properties.

19. The adhesive composition of claim 3, wherein the adhesive composition possesses at least one property selected from the group consisting of: (a) tack sufficient to pull labels from a magazine at 350 ft/min linear speed and/or at 750 labels/min without dropping more than 0.5% of all labels in a five-minute test; (b) a viscosity of 1,000 to 2,500 cps in an uncured state; (c) a peel strength greater than 1200 gm/3 inches when cured to 90% of monomer as measured with a glass bottle at a temperature of 75° F. (23.9° C.); (d) curing efficiency sufficient to cure to 90% of monomer within 1 sec of being radiated with 12 mJ/cm² of UVC light; and (e) an ability to cure to provide a substantially bubble-free surface.

20. The adhesive composition of claim 16, wherein the adhesive composition possesses all of the properties.

21. An adhesive composition comprising:
at least one oligomer having a weight average molecular weight of at least 10,000 Da and an average functionality from 1 to 2;
at least one monomer;
at least one initiator; and
optionally at least one tackifier,
wherein the adhesive composition possesses all of the following properties: (a) tack sufficient to pull labels from a magazine at 350 ft/min linear speed and/or at 750 labels/min without dropping more than 0.5% of all labels in a five-minute test; (b) a viscosity of 1,000 to 2,500 cps in an uncured state; (c) a peel strength greater than 1200 gm/3 inches when cured to 90% of monomer as measured with a glass bottle at a temperature of 75° F. (23.9° C.); (d) curing efficiency sufficient to cure to 90% of monomer within 1 sec of being radiated with 12 mJ/cm² of UVC light; and (e) an ability to cure to provide a substantially bubble-free surface.

22. In a process for applying a label to a surface of a container, comprising applying a radiation curable adhesive to a transfer member, transferring the adhesive from the transfer member to a label, irradiating the adhesive on the label to cure the adhesive and applying the label to the surface of the container before the adhesive has cured, the improvement wherein the adhesive consists of the adhesive composition of claim 1.

23. The process of claim 22, wherein labels are transferred from a magazine to containers at 350 ft/min linear speed and/or at 750 labels/min without dropping more than 0.5% of all labels over a period of at least 5 minutes.

24. The process of claim 22, wherein the adhesive is applied substantially uniformly over a surface of the label.

25. The process of claim 22, wherein the container is a glass bottle and a peel strength of the adhesive on the glass bottle is greater than 1200 gm/3 inches at a temperature of 75° F. (23.9° C.).

26. The process of claim 22, wherein the adhesive cures to 90% of monomer within 1 sec of being radiated with 12 mJ/cm² of UVC light.

27. The process of claim 22, wherein the adhesive cures to provide a substantially bubble-free surface.

28. The process of claim 22, wherein the average functionality of the at least one oligomer is greater than 1, and the at least one oligomer and the at least one monomer are urethane acrylates.

29. The process of claim 22, wherein the molecular weight of the at least one oligomer is less than or equal to 15,000 Da and a monomer:oligomer ratio is from 1.8:1 to 3:1.

30. The process of claim 22, wherein the adhesive comprises the tackifier having a Tg of at least 64° C., and the adhesive has a Tg less than −25° C.

31. A copolymer produced by polymerizing the composition of claim 1.
